(19) United States
(12) Patent Application Publication
(10) Pub. No.: US 2018/0204153 A1
(43) Pub. Date: Jul. 19, 2018

(54) Architectural Planning Method

(71) Applicant: Chun-Sheng Chiang, Sanxing Township (TW)

(72) Inventor: Chun-Sheng Chiang, Sanxing Township (TW)

(21) Appl. No.: 15/823,219

(22) Filed: Nov. 27, 2017

(30) Foreign Application Priority Data
Jan. 17, 2017 (TW) 106101510

(51) Int. Cl. G06Q 10/06; G06T 17/00

(52) U.S. Cl. CPC G06Q 10/0631; G06T 17/00

(57) ABSTRACT

An architectural planning method comprises:
A. Receiving an authorization instruction as sent from a client's end to a main controller (or architect);
B. Obtaining a real image composed of a master or main image of the designated main area of the architectural planning, and a peripheral image of a surrounding area around the main area, and transmitting the real image to a rear-end processing unit;
C. Producing a three-dimensional or 3D image model as originated from the real image;
D. Further implementing a 3D virtual architectural construction image into a designated coordinate area in the 3D image model; and
E. Compiling the 3D image model and 3D virtual construction image to be a 3D architectural planning image.

### BACKGROUND OF THE INVENTION

A conventional architectural planning is done by a designer or architect by receiving an instruction from a client. The designer must attend the construction or building site to conduct a plurality of surveys, and then make a plurality of drawings for his or her construction design based on the survey.

Such a conventional architectural planning has the following drawbacks:
1. It takes time to manually survey and make drawing for the planned construction site, thereby consuming time and increasing planning cost.
2. The construction, building and the surrounding landscape should be drawn respectively, thereby prolonging or delaying the design and planning time.
3. The drawing is manually drawn to artificially simulate the construction or building as planned without the aid of 3D (three-dimensional) image to show the construction, building and its surroundings, so that the client may not advancedly visualize the real image of the construction or building as planned when he or she is checking the drawing as submitted by the architect or designer. So, the suspect, misleading even conflict may be caused between the client and the designer.
4. The drawing just shows the two-dimensional (2D) image of the construction, building and its surrounding, which is planar, and therefore difficult to vividly show the construction, building and its surroundings in a stereoscopic way, thereby being unable to satisfy the client's requirements and still necessary to seek more improvements therefor.

### SUMMARY OF THE INVENTION

The object of the present invention is to provide an architectural planning method, including: making a three-dimensional image model and further implementing a three-dimensional virtual architectural construction or building within or on the three-dimensional image model to integrate a three-dimensional architectural planning image.

A further object of the present invention is to provide an architectural planning method comprising:
A. Receiving an authorization instruction as sent from a client's end to a main controller end, or an architect or designer end;
B. Obtaining a real image composed of a master or main image of the designated main area of the architectural planning, and a peripheral image of a surrounding area around the main area, and transmitting the real image to a rear-end processing unit;
C. Producing a stereoscopic (or three-dimensional, or 3D) image model as originated from the real image by the rear-end processing unit;
D. Further implementing a 3D virtual architectural building or construction image into a designated coordinate position or area in the stereoscopic or 3D image model; and
E. Compiling or integrating the 3D image model and 3D virtual building or construction image to be a 3D architectural planning image, and transmitting the architectural planning image to the client's end to be checked or confirmed by the client.

### BRIEF DESCRIPTION OF THE DRAWINGS

FIG. 1 shows a process flow chart of the present invention.

FIG. 2 shows a modified flow chart based on FIG. 1.

FIG. 3 shows another modified flow chart based on FIG. 1

### DETAILED DESCRIPTION

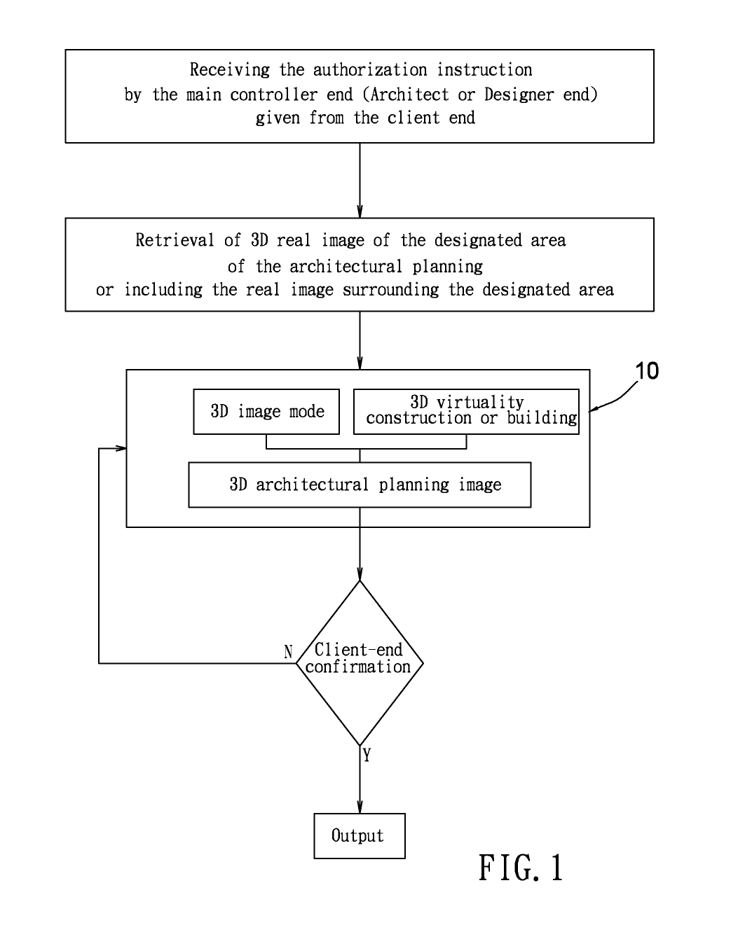

As shown in FIGS. 1˜3, the present invention discloses an architectural planning method, comprising:
A. Receiving an authorization instruction as sent from a client's end to a main controller end, or an architect or designer end;
B. Obtaining a real image composed of a master or main image of the designated main area of the architectural planning, and a peripheral image of a surrounding or outer area around the main area, and transmitting the real image to a rear-end processing unit (10);
C. Producing a stereoscopic (or three-dimensional, or 3D) image model as originated from the real image by said rear-end processing unit (10);
D. Further implementing a 3D virtual architectural building or construction image on a designated coordinate position or area of the stereoscopic or 3D image model; and
E. Compiling or integrating the 3D image model and 3D virtual building or construction image to be an architectural planning image, and transmitting the architectural planning image to the client's end to be checked or confirmed by the client.

The real image as defined in this invention indicates a true image of an object, a site, a landscape, a place or an area; while the virtual image is a simulated image which does not exist in the real world.

After finishing the architectural planning image, it may be sent, transmitted or handed over to the client end to be checked or confirmed by the client. If the client approves it, such an architectural planning is completed. If it is rejected by the client, a change or modification of the architectural planning may be returned to the rear-end processing unit (10) for further modification, processing or treatment, until being finally accepted by the client.

In accordance with the architectural planning method of this invention, the architect or designer (or the main controller end) may not attend the construction site to conduct many detailed surveys and then make many drawings for the designated or specified area planned to be constructed or built and for the surroundings, such as roads, cars, trees or existing buildings. He or she may take pictures, through a camera or a camera mounted on an unmanned aerial vehicle (UAV) or a drone with camera, to obtain real image of the construction site. The real image of the designated area and its surroundings is then sent or transmitted to the rear-end processing unit (10) to process and convert the real image (including plural files of photographs, pictures or images) to be a three-dimensional (3D) image model. Such a 3D image model may include OBJ (object file), STL (Standard Template Library), etc., but not limited in the present invention. Such a 3D real image will present the real image in the construction site and its surroundings including landforms and objects thereon. Therefore, the architect will no longer attend the construction site to make many surveys and drawings to greatly save time and cost for an architectural planning and design.

Since a virtual image of planned construction or building is incorporated into the 3D real image model, the construction or building, which will be finished in the future, may be visualized in advance so that the difference between the client and the architect (or designer) will be minimized. From the virtual image as co-existing with the 3D image model, the whole design, or lay-out will be clearly observed, reviewed and discussed so as to make easier modifications or revisions on the planned construction, thereby easily reaching a better mutual understanding between the client and the architect, and minimizing any misleading or conflict thus caused.

The architectural planning method of the present invention may be applied to the architectural planning including: housing, civil engineering, landscape, river and river side, mountain slope, etc., not limited in this invention.

The images as prepared by the present invention may include the 3D real image of the construction site without incorporation of the virtually construction (or building) incorporated in the real image; and the 3D image consisting of the real image of the construction site having the virtual construction (or building) incorporated therein for client's comparison “before” the construction and “after” the construction of the planning.

The images may include a primary real image just showing the original construction site; an intermediate image when the virtual construction is under construction; and a final image when the virtual construction has been well set up on the real image. So, the client may check or review the planning from time to time in several stages, namely, the original view, the view at the intermediate or under-construction stage, and the final view. This may help a better architectural planning with minimum defects.

The 3D image model of the present invention may be created or produced by a proper software, including S MAX and Sketchup, but not limited in this invention.

Regarding the rear-end processing unit (10) of the present invention, a pixel database may be used to create or produce those virtual structures, objects, constructions or buildings.

The architectural objects for simulating the tables, chairs, walls, tiles, handrails, street lamps, bridges, landscape decoration articles, etc., having different or varied sizes, are pre-stored in the pixel database or any other databases for storing the picture elements. Upon selection and implementation of the desired 3D virtual architectural objects or constructions as retrieved from the database, they may then be built, implanted, of inserted on the specified location on the 3D image model which is a real image as previously obtained and transformed from the real construction site. By the way, a 3D architectural planning image will be finished by integrating the 3D real image with the 3D virtual architectural objects or constructions.

The real image for making the 3D image model of the present invention may be obtained in a specified or pre-set area and its surrounding in an operation area or zone by taking pictures or photographs through a camera carried by or mounted on a person, a drone, an unmanned aerial vehicle (UAV), a mobile vehicle, or a satellite. The real image as taken by the camera may be stored in an electronic image file for transmission, retrieval and processing. Such electronic image files include: electronic video files, such as: avi (audio video interleave), wmv (windows media video), mov, mp4, rm, etc. The electronic picture files include: jpg, png, tif, gif, pcl, etc. The electronic files are not limited in the present invention.

A specified or designated area may refer to a 3D virtual construction area or range, for instance, an interior in a 3D virtual construction, or a surrounding area including nearby roads, houses, trees, rivers, bridges, etc.

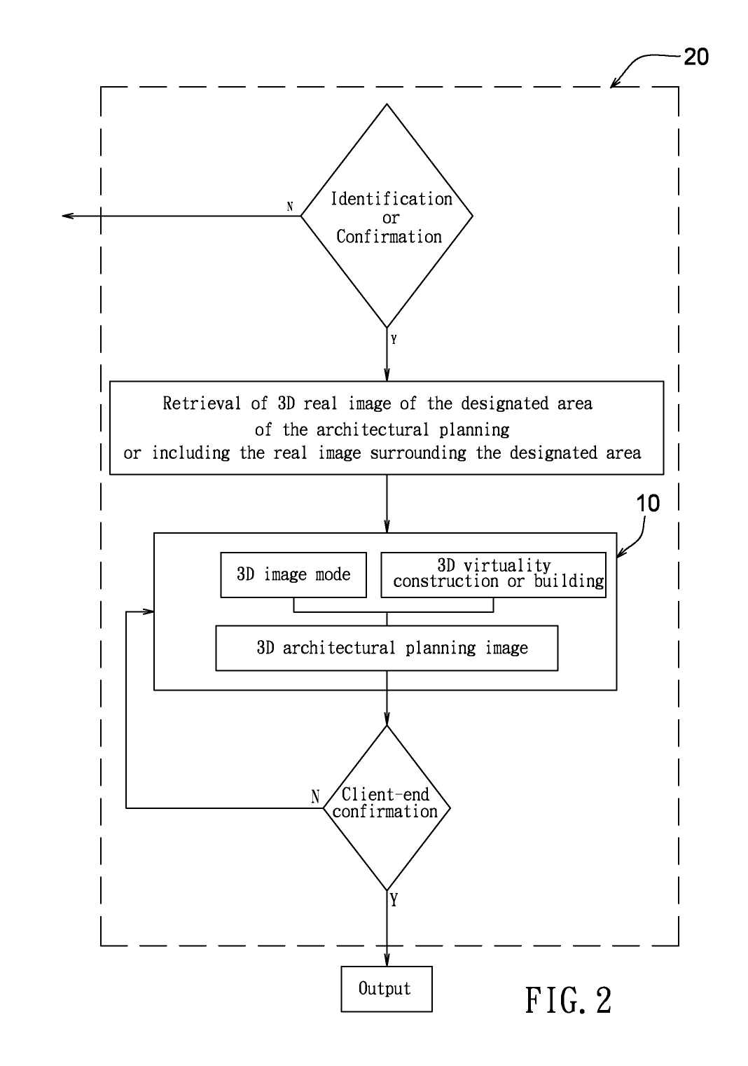

The rear-end processing unit (10) is built in an operation platform (20) as shown in FIG. 2. The operation platform (20) may be linked with an operation station, a cloud-based server, a personal computer, or a mobile phone.

As shown in FIG. 2, the operation platform (20) may be operated with a wired or wireless connection with its linking systems or the like. The present invention may be directly applied in a construction site or a client's end, so that the images may be transmitted to the operation platform (20) in order to enter the rear-end processing unit (10) for setting up or building the 3D architectural planning (including virutality construction) or its revision or modification.

As shown in FIG. 2, a process step of Identification/Confirmation must be incorporated in the architectural planning method of the present invention. Upon an affirmative identification (numeral “Y”) of a client's instruction or order, the client's authorization instruction is confirmed so that a 3D real image of the designated area of the architectural planning, including a 3D real image surrounding the designated area may be retrieved. If the indentification is not confirmed or is incorrect (numeral “N”), the instruction will be denied or rejected automatically.

The “input” entity to enter the operation platform (20) of FIG. 2 may be either the client end or the main controller end (the architect or designer end). The operation platform (20) will authorize different operational permits or rights, depending upon the client end or the main controller end.

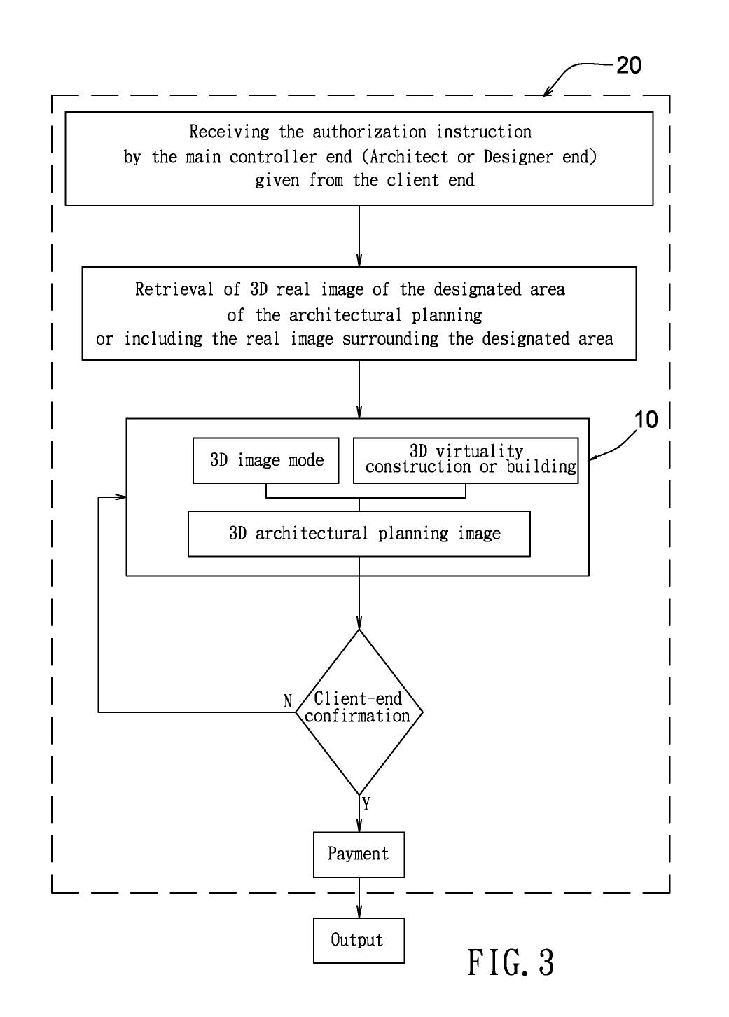

As shown in FIG. 2 or FIG. 3, the architectural planning method of the present invention further comprises an “Output” step. The architectural planning image, after being confirmed without mistake by the client, may be output to be displayed on a monitor or screen, or be stored in a memory media. Such an output image may be transmitted as an engineering drawing, a picture, or an engineering electronic file, electronic picture file, or electronic video file, not limited in this invention. The memory media may include: CD, hard disk, cloud hard disk, portable hard disk, Random Access Memory (RAM), etc., not limited in this invention.

As shown in FIG. 3, the architectural planning method of the present invention further comprises a “Payment” step, through which step, only the payment being paid by the client end and received by the main controller end (the architect or designer end), the architectural planning image, once being confirmed by the client end, will then be output towards the client end.

In the above-mentioned Payment step, the payment may be paid by the client or by a third party by means of cash payment, remittance, transfer payment, credit card, debit-card, ATM card or down payment, not limited in the present invention.

The rear-end processing unit (10) of the present invention further comprises the processing of filling, deletion, stretch and any other compiling on the specified area of the 3D image model for an optimum design of the architectural planning.

The rear-end processing unit (10) of the present invention may further retrieve the survey map after a practical survey on the construction site, or retrieve the topography or cadastral map as produced or recorded in a governmental agency. Then, the rear-end processing unit (10) may position the 3D image model on a corresponding location or position on the survey map, the topography or the cadastral map; and also make any calibration for precisely positioning the 3D image model on such maps.

The retrieved survey map, topography or cadastral map as retrieved by the rear-end processing unit (10) may be superimposingly displayed on a corresponding area or location on the 3D image model or the 3D architectural planning image (including the virtual construction). By the way, the 3D virtual construction to be built in the future will be precisely set up at the precise location advancedly. Meanwhile, the client may also “observe” or visualize the 3D architectural planning image (as finished in future), by superimposingly displaying the survey map, the topography or the cadastral map on such a 3D architectural planning image as finished.

The present invention has the following advantages:
1. There is no need to make a lot of surveys and drawings of the construction site including the landform or landscape (before or after the construction) to shorten the architectural planning time and cost.
2. The client may observe or visualize the real or virtual image before, during and after the construction, easily understanding the architectural planning, thereby facilitating the confirmation by the client end.
3. Since the 3D image of the architectural planning may show the future real and virtual image of the construction including the surrounding or nearby landscape at the planning stage, the client may thus clearly visualize or “observe” the future construction as finished and the surrounding landscape so as to prevent from misleading or conflict between the client and the architect or designer.
4. The architectural planning of this invention can be remotely controlled or executed so that the main controller end (the architect or designer) may instantly revise or amend the related items of the planning objects or subjects in order to be quickly checked or confirmed by the client end, thereby facilitating the job and increasing the work efficiency.
5. By aid of the reciprocative operation platform, the client may involve or join the planning design and output of engineering drawings and files voluntarily or actively, thereby optimizing the architectural planning.

The present invention may be further modified without departing from the spirit and scope of the present invention.

I claim:

1. An architectural planning method comprising the steps of:
A. Receiving an authorization instruction of an architectural planning, as sent from a client end, by a main controller end or an architect end;
B. Retrieving at least one real image of a designated area of the architectural planning of said authorization instruction, including a real image of a peripheral or outer area surrounding said designated area of said architectural planning;
C. Transmitting or transferring said real image to a rear-end processing unit to build a three-dimensional (3D) image model as processed by said rear-end processing unit;
D. Building a 3D virtual construction image, at a pre-set coordinate area or position on said 3D image model; and
E. Integrating or compiling said 3D image model with said 3D virtual construction image to be a 3D architectural planning image, adapted to be transmitted, reciprocatively transmitted, observed, checked, revised, or confirmed by said client end or said main controller end.

2. An architectural planning method according to claim 1, wherein said real image is obtained by taking picture through a camera carried or mounted on a person, a drone, an aircraft, a vehicle, or a satellite.

3. An architectural planning method according to claim 1, wherein said rear-end processing unit further comprises filling, deletion or stretch compiling on a pre-set area or position on said 3D image model.

4. An architectural planning method according to claim 1, wherein said rear-end processing unit is built or installed on an operation platform.

5. An architectural planning method according to claim 4, wherein said operation platform is built or installed in a work station, a cloud server, a personal computer and a mobile or cellular phone.

6. An architectural planning method according to claim 4, wherein said operation platform is operated through wire or wireless connection.

7. An architectural planning method according to claim 4, wherein said operation platform further comprises an input of an identification or confirmation signal into said operation platform, whereby upon an affirmative conformation of an identification or confirmation, an authorization instruction given by said client end to be received by said main controller end is permitted.

8. An architectural planning method according to claim 7, wherein said operation platform comprises identification of said client end or said main controller end.

9. An architectural planning method according to claim 1, wherein said architectural planning method further comprises an output step, said output step operatively outputting a paper-based engineering drawing or picture of said 3D architectural planning image; or operatively outputting an electronic file including engineering drawing, picture, or video files, to be displayed on a display or stored in a memory media.

10. An architectural planning method according to claim 9, wherein said architectural planning method further comprises a payment step, whereby upon access of said client end into said operation platform and a payment paid by said client end, said client end is permitted to enter said operation platform to conduct the output step.

11. An architectural planning method according to claim 9, wherein said memory media comprises a CD, a hard disk, a cloud hard disk, a portable hard disk or a RAM.

12. An architectural planning method according to claim 1, wherein said rear-end processing unit further comprises retrieval of a survey map, a topography or a cadastral map; and positioning and calibrating said 3D image model on a corresponding location of said 3D image model on said survey map, or said topography or said cadastral map.

13. An architectural planning method according to claim 1, wherein said rear-end processing unit comprises retrieval of a survey map, a topography or a cadastral map; and superimposingly displaying said survey map, said topography or said cadastral map on a corresponding location on said 3D image model or said 3D architectural planning image.

14. An architectural planning method according to claim 1, wherein said rear-end processing unit comprises pre-setting a pixel database, including a plurality of different 3D virtual architectural objects each having a pre-set dimension or size; setting up an operation zone for building the 3D image model by said real image of said designated area and the surrounding area as retrieved; and building the 3D virtual architectural objects, as retrieved from said pixel database, on a pre-set location on said 3D image model, thereby integrating an architectural planning image consisting of said 3D image model and said 3D virtual architectural objects.

15. An architectural planning method according to claim 1, wherein said architectural planning image comprises an initial 3D image before the building of said 3D virtual construction on said 3D image model, and a final 3D image after the building of said 3D virtual construction on said 3D image model.

16. An architectural planning method according to claim 1, wherein said architectural planning image comprises: an initial 3D image before the building of said 3D virtual construction on said 3D image 3D; an intermediate 3D image showing the image under installation of said 3D virtual construction on said 3D image model; and a final 3D image after complete the building of said 3D virtual construction on said 3D image model.
